(19) United States
(12) Patent Application Publication
(10) Pub. No.: US 2005/0102621 A1
(43) Pub. Date: May 12, 2005

(54) Clean dash instrument cluster

(75) Inventors: Vyacheslav B. Birman, Sterling Heights, MI (US); Werner Eckardt, Rochester, MI (US); Christian Tanguy, Sterling Heights, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation

(21) Appl. No.: 10/400,851

(22) Filed: Mar. 27, 2003

Related U.S. Application Data
(60) Provisional application No. 60/370,325, filed on Apr. 5, 2002.

(51) Int. Cl. G09G 5/00

(52) U.S. Cl. 715/700

(57) ABSTRACT

An instrument display system provides vehicle information where a driver and passenger side of a vehicle dash have primarily identical appearances when the display system is not activated. The instrument display system includes a primary light system, a primary optical system, and a semitransparent screen used to produce an image of at least one instrument gauge. The primary optical system directs a light from the primary light system to the semitransparent screen, which is attached to the vehicle dash. The semitransparent screen has a similar appearance to the dash. Thus, when the instrument display system is turned off the semitransparent screen blends with the dash. Other embodiments may use additional light systems and optical systems, such that the scales and indicator for an instrument gauge are produced separately, yet displayed in the same location of the dash.

The present application claims priority to U.S. Provisional Patent Application Ser. No. 60/370,325, filed Apr. 5, 2002.

### BACKGROUND OF THE INVENTION

The present invention relates to a display for an instrument panel and more particularly to an instrument panel display in an automotive vehicle, which utilizes a semitransparent screen for viewing instrument information within a vehicle.

Commonly, a vehicle is arranged to have instrument gauges placed within a dash of a vehicle for easy viewing by a driver. The instruments generally include vehicle information that is helpful to the driver, such as speed, mileage, fuel, and other engine information. Instrument gauges in vehicles are displayed such that the gauges are placed within a recessed portion of the vehicle dash. The gauges are grouped together to form an instrument cluster. The instrument clusters are generally illuminated from behind for viewing by a vehicle operator. The instrument clusters typically take up a large portion of the dash. The large recessed area that is required to receive and position the instrument for viewing creates an aesthetically unpleasant look when viewing the vehicle dash. Further the recessed area takes up a significant amount of packaging space within the dash that could be used for other dash mounted components.

Accordingly, it is desirable to provide an instrument display, which is easily viewed by the driver, increases packaging space for other components, and which is aesthetically appealing.

### SUMMARY OF THE INVENTION

The instrument display system according to the present invention provides a system for displaying vehicle information where driver and passenger sides of a vehicle dash have primarily identical appearances when the display system is not activated. The display system is positioned behind the dash such that when the display system is activated, an image of vehicle operating conditions is displayed on the driver side of the vehicle dash.

The instrument display system includes a primary light system, a primary optical system, and a semitransparent screen. The primary light system produces light and the primary optical system directs the light from the primary light system to the semitransparent screen, which is attached to the vehicle dash. Because the screen is semitransparent, the image can be viewed from the interior of the vehicle. The semitransparent screen has a similar appearance to the dash. Thus, when the instrument display system is not activated the semitransparent screen blends with the dash. The semitransparent screen is formed such that there is low amount of reflection from indirect light sources such as the sun. This reduces the glare on the dash making the instrument display easier to read.

In one disclosed embodiment, the primary optical system is preferably a reflector, such as a mirror placed on a scanner. The mirror receives the light produced by the primary light system and reflects it onto the semitransparent screen.

In another embodiment, the system includes a second light source. The image produced by the primary light system and primary optical system is preferably that of a pointer. The second light source illuminates a scale. A second optical system directs the image of the scale onto the semitransparent screen. The second optical system is preferably a lens. The image from the primary light system and primary optical system is displayed in the same location as the image from the second light source and second optical system. Thus, when viewed on the semitransparent screen the images correspond to display an instrument gauge comprising a scale and pointer that indicate a current vehicle condition.

In another embodiment, in addition to the primary light system and primary optical system, there is a guide light source and a scale placed behind the semitransparent screen. As light from the guide light source passes through the scale, an image of a scale is displayed on the semitransparent screen. An image of a pointer is produced by the primary light system and primary optical system to correspond with a vehicle condition and is projected onto the semitransparent screen to relate with the image of the scale.

In another embodiment, the primary light system includes a pointer that is located between a primary light source and a primary optical system. The primary light source is positioned to illuminate the pointer. An electric motor is activated to change the position of the pointer to reflect changes in the vehicle condition. The primary optical system directs the image of the pointer on the semitransparent screen. In this embodiment the primary optical system is preferably one or more lenses. In addition, there is a guide light source, and a light guide placed behind the semitransparent screen. The image of the pointer corresponds with the image of the scale to display an instrument gauge.

The present invention therefore provides a system for displaying vehicle information on a semitransparent screen mounted to a dash where the images can be easily viewed by a vehicle operator. In addition, the appearance of the dash is the same between the driver and passenger side when the display is not activated.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1a is an environmental view of the present invention.

FIG. 1b is a cross-sectional view through the dash showing the present invention

FIG. 2 is a general schematic view of a first embodiment of the present invention;

FIG. 3 is a schematic view of a second embodiment of the present invention;

FIG. 4 is a schematic view of a third embodiment of the present invention;

FIG. 5 is a schematic view of a fourth embodiment of the present invention; and

FIG. 6 shows an example of a scale and pointer.

### DETAILED DESCRIPTION OF THE PREFERRED EMBODIMENT

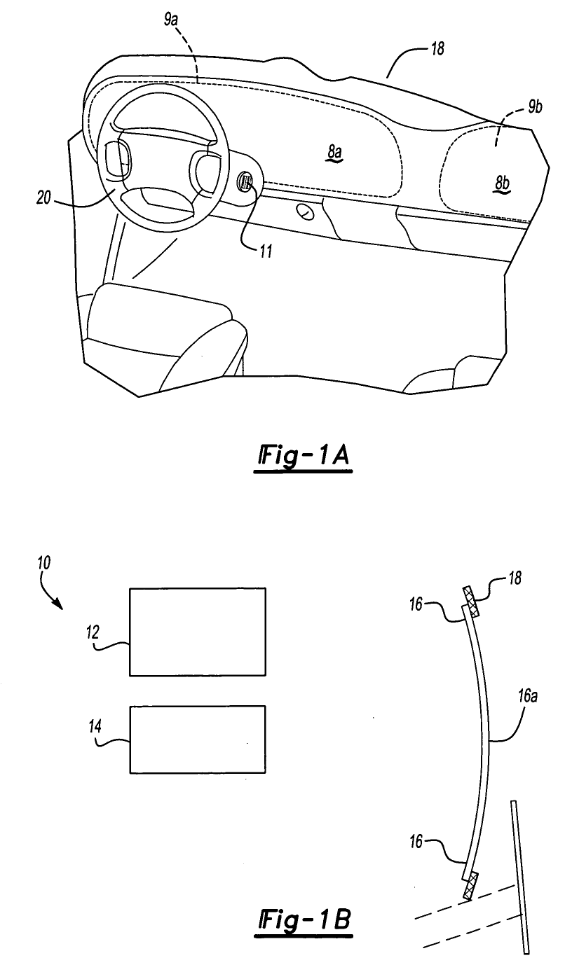

FIG. 1A illustrates an environmental view of an instrument display system 10. A vehicle dash 18 is shown. A first surface 8a of the vehicle dash 18 is generally indicated by dashed line 9a. The first surface 8a faces a driver side of the vehicle. A second surface 8b of the vehicle dash is generally indicated by dashed line 9b. The second surface 8b faces a passenger side of the vehicle. The first surface 8a and the second surface 8b have primarily identical appearances when the display system 10 is not activated. Turning a key in an ignition 11, starting a vehicle, or activating some other similar switch activates the display system 10. The instrument display system 10 is positioned to be hidden by the dash 18. When the display system 10 is activated, an image including information pertaining to various types of vehicle conditions is displayed on the first surface 8a of the vehicle dash 18. FIG. 1B shows a cross section of the first area 8a showing the display system positioned behind the dash 18.

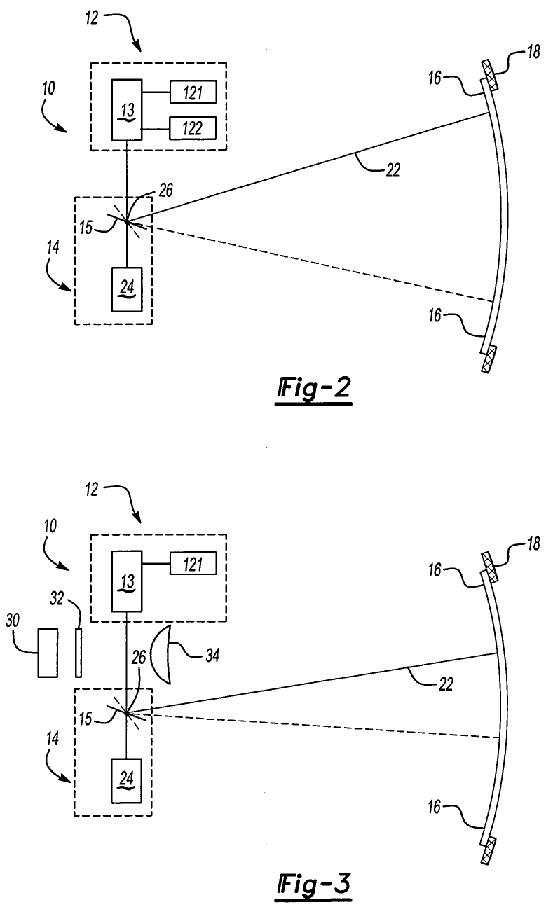

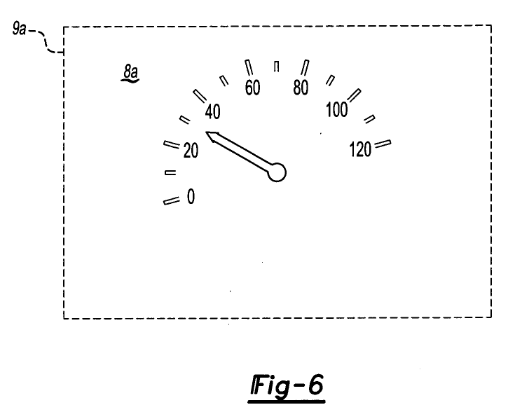

FIG. 2 shows a general schematic view of an instrument display system 10. The instrument display system 10 actively displays vehicle operating condition information that is continuously updated. The instruments displayed may include a gas gauge, a speedometer, a tachometer, and other instruments, which provide a vehicle operator with useful information. These instruments typically include a scale that extends from an initial value such as 0 to a predetermined maximum value. An example of this is shown in FIG. 6. A speedometer includes a scale of 0 miles per hour (mph) to 120 mph with a pointer that moves relative to scale to indicate the current vehicle speed.

The instrument display system 10 includes a primary light system 12, a primary optical system 14, and a semitransparent screen 16. The primary light system 12 is positioned behind the vehicle dash 18. The primary light system 12 and optical system 14 construct an optical image. The primary optical system 14 directs the light from the primary light system 12 to the semitransparent screen 16, which is attached to the vehicle dash 18. (The transmission beam path is shown schematically as line 22.)

The dash 18 may have a cutout portion in area 8a. The semitransparent screen 16 is attached to the dash 18 to cover the cutout portion thus giving the dash 18 a continuous appearance. Because the screen 16 is semitransparent, light projected onto the screen 16 behind the dash 18 may be viewed from the interior of the vehicle, although the screen 16 has a blank appearance when there is no image projected. The semitransparent screen 16 may be attached to the dash 18 by an adhesive or fasteners or other known means of attachment. For convenience, the semitransparent screen 16 may be mounted either in front of or behind the dash 18. The semitransparent screen 16 appears to be the same color as the rest of the dash and is preferably black. In addition, the semitransparent screen 16 has a matte appearance on a front side 16a, which faces the vehicle interior when installed. The matte appearance reduces glare and enhances the appearance of the semitransparent screen 16. The back side 16b of the semitransparent screen 16 has a glossy appearance for the image to be projected onto. The semitransparent screen 16 can be shaped to have a similar curvature as the passenger side 8b of the dash 18.

In one embodiment of the instrument display system 10 the primary light system 12 includes a primary collimated light source 13 and first and second modulators 121, 122. The primary optical system 14 includes a reflector 15 and scanner 24. The reflector 15 is preferably a mirror or a microelectromechanical system (MEM) or some other device that reflects light. In this embodiment the reflector 15 is a mirror attached to the scanner 24.

The primary light system 12 comprises a light source 13, which cooperates with the first modulator 121, and the second modulator 122, to produce light at a wavelength defined by each modulator. That is, the first modulator 121 modulates light of a first wavelength and the second modulator 122 modulates light of a second wavelength that is different than the first wavelength. When the first modulator 121 or the second modulator 122 is in an ON position, the primary light source 13 provides light at a the defined wavelength. The mirror 15 focuses the light from the primary light source 13 in a point or a small area of the semitransparent screen 16. When both the first modulator 121 and the second modulator 122 are in the OFF position, no light is produced. Thus, the area on the semitransparent screen 16 corresponding to the scanner 22 position at that time remains blank. The areas of the semitransparent screen 16 where the light is focused are grouped to form an image.

For example, when the light is focused in the region where a scale should be displayed, the first modulator 121 is in an ON position and the second modulator 122 is in an OFF position. Thus, the scale is displayed in a first color determined by the wavelength produced from the first modulator 121. Likewise, when the light is focused is in the region where a pointer should be displayed, the second modulator 122 is in an ON position and the first modulator 121 is in an OFF position. The scanner 24 is capable of scanning in two directions. High frequency of scanning provides permanent appearance of a scale and pointer.

The pointer is used to indicate a current vehicle condition on the appropriate scale for the instrument(s) being displayed. For instance, if the instrument displayed is a speedometer the scale may read from 0 mph to 120 mph. The pointer would indicate the current speed of the vehicle. In addition, the image produced may show only portions of a scale in order to decrease both size of the screen and angle of the scanner motion. That is, only the portion of a scale surrounding the location of the pointer may be illuminated at one time. In the previous example, if the pointer was located at 30 mph, only the portion of the scale from 20 mph to 40 mph may be displayed. As the pointer moves to reflect changes in the vehicle conditions, the scale is changed to remain illuminated around the pointer. The unnecessary portions of the scale are not shown until needed.

In another embodiment, shown in FIG. 3, the primary light system 12 comprises a primary light source 13 and a first modulator 121. The optical system 14 includes a scanner 24 and a reflector 15, which is preferably a mirror. The primary light system 12, the optical system 14, and the semitransparent screen 16 operate in the same fashion as described above. However, one difference is that the primary light source 13 radiates one wavelength and is connected to one modulator 121. The primary optical system 14 creates an image of only a pointer or a scale. In this embodiment there is an additional or second light source 30. The second light source 30 radiates light at a different wavelength than the primary light source 13, such that the second light source 30 is a different color than the primary light source 13. The image produced by the primary light system 12, and the primary optical system 14 is preferably that of a pointer.

The second light source 30 is located to illuminate scales 32. An additional or second optical system 34 is placed between the scales 32 and the semitransparent screen 16. The second optical system 34 is preferably a lens, but may include more than one lens. The second light source 30 is directed toward the scales 32. The lens 34 constructs the image of the scales 32 on the surface of the semitransparent screen 16. The image of the pointers, constructed by the primary light system 12, and the primary optical system 14 is displayed in the same location as the image of scales 32 constructed by the second light source 30 and second optical system 34. Thus, when viewed on the semitransparent screen 16, the scale and pointer images correspond to display an instrument gauge indicating a current vehicle condition. By differing the modulation and scanning of the light, the position of the pointer changes to reflect changes in the vehicle condition. Again, the entire scale 32 may be illuminated at once, or only a portion that is needed around the location of the pointer may be illuminated.

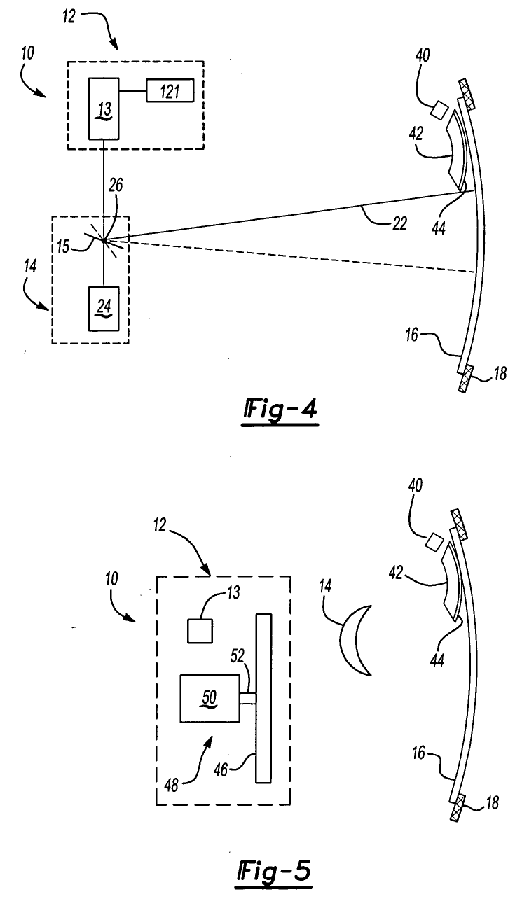

FIG. 4 shows another embodiment. In this embodiment the primary light system 12 includes a primary light source 13 and a modulator 121. The primary optical system 14 is a reflector 15 and a scanner 24. In addition, there is a guide light source 40 and a light guide 42 located behind the semitransparent screen 16. The guide light source 40 radiates light at a wavelength different from the primary light source 13. Graphics 44 may be printed on the surface of the light guide 42 closest to the semitransparent screen 16. The graphics 44 can be printed using a material having refractive index higher than the material used to form the light guide 42, and may be mixed with small particles to scatter the light. Thus, the graphics 44 are seen through the semitransparent screen 16. Preferably, the graphics 44 are that of a scale. In areas where there is an absence of graphics, total internal reflection occurs, consequently this area looks black. An image of a pointer is produced on the surface of the screen by the primary optical system 14 and primary light system 12.

In another embodiment, shown in FIG. 5, the primary light system 12 includes a light source 13, a pointer 46, and a movement mechanism 48. The primary optical system 14 is preferably one or more lenses. The movement mechanism 48 includes a motor 50 and a shaft 52 that controls movement of the pointer 46. The motor is preferably an electric motor and is activated to change the position of the pointer to reflect changes in vehicle conditions. The pointer is placed between the primary light source 13 and the semitransparent screen 16 such that the primary light source 13 illuminates the pointer 46. Alternatively the pointer 46 may be illuminated by a prism element in the pointer 46 that redirects the light, or the movement mechanism 48 may rotate the light source 13 at the same time as the pointer 46. The image of the pointer 46 is displayed on the semitransparent screen 16.

In addition, there is a guide light source 40 and a light guide 42 located at the rear side of the semitransparent screen 16. The guide light source 40 radiates light at a wavelength different from the primary light source 13. The guide light source 40 is positioned to illuminate the light guide 42. Graphics 44 may be printed on the surface of a light guide 42 closest to the semitransparent screen 16. The graphics 44 can be printed using a material having refractive index higher than the material used to form the light guide 42, and may be mixed with small particles to scatter the light. Thus, the graphics 44 are seen through the semitransparent screen 16. Preferably the graphics 44 form the image of a scale. The projected image of the pointer 46 corresponds with the image of the scale to display an instrument gauge.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A vehicle instrument panel display comprising:
a semitransparent screen supported by a vehicle dash;
a primary light system mounted behind said dash, said primary light system transmitting a light; and
a primary optical system cooperating with said primary light system to direct said light onto said semitransparent screen to display an optical image of at least one variable vehicle condition.

2. The instrument panel display as recited in claim 1 wherein said semitransparent screen has the same curvature as said dash.

3. The instrument panel display as recited in claim 1 wherein said semitransparent screen is attached to said dash by an adhesive.

4. The instrument panel display as recited in claim 1 wherein said at least one vehicle condition is displayed only when a vehicle ignition is activated.

5. The instrument panel display as recited in claim 1 wherein said primary optical system comprises a scanner and a reflector mounted to said scanner.

6. The instrument panel display as recited in claim 5 wherein said reflector is mounted for movement relative to said primary light system.

7. The instrument panel display as recited in claim 6 wherein said reflector is controlled by said scanner.

8. The instrument panel display as recited in claim 7 wherein said reflector pivots about a fixed pivot point to vary a transmission path of said optical image.

9. The instrument panel display as recited in claim 1 wherein said primary light system comprises a primary light source and at least a first modulator.

10. The instrument display panel as recited in claim 9 wherein said primary light system further includes a second modulator connected to said light source.

11. The instrument panel display as recited in claim 10 wherein said first modulator modulates light at a first wavelength and said second modulator modulates light at a second wavelength, different then said first wavelength.

12. The instrument panel display as recited in claim 10 wherein said optical image comprises at least one image of a scale.

13. The instrument panel display as recited in claim 12 wherein said optical image further comprises a numerical value with said scale surrounding said value.

14. The instrument panel display as recited in claim 13 wherein said optical image comprises at least one image of a pointer.

15. The instrument display as recited in claim 9 including a second light source mounted behind said dash and a scale positioned to be illuminated by said second light source wherein said primary light system and primary optical system cooperate with said second light source and said scale to project an illuminated scale and pointer image onto said semitransparent screen to display said at least one variable vehicle condition.

16. The instrument panel display as recited in claim 15 wherein said primary light source radiates a first light having a first color and said second light source radiates a second light having a second color different than said first color.

17. The instrument panel display as recited in claim 1 including a guide light source mounted adjacent said vehicle dash and a light guide positioned to be illuminated by said guide light source wherein said guide light source and light guide cooperate with said primary light system and primary optical system to display a plurality of said variable vehicle conditions on said vehicle dash.

18. The instrument panel display as recited in claim 17 wherein said guide light source and light guide generate a scale display and said primary optical system and primary light system generate a pointer display

19. The instrument panel display as recited in claim 18 wherein said scale is printed on said light guide and has a greater refractive index than said light guide.

20. The instrument panel display as recited in claim 18 including a pointer positioned to be illuminated by said primary light system.

21. The instrument panel display as recited in claim 20 wherein said pointer is mounted for movement relative to said semitransparent screen.

22. The instrument display panel as recited in claim 21 further including an electric motor operably coupled to said pointer to adjust pointer position

23. The instrument display panel as recited in claim 1 wherein said vehicle dash includes a first surface facing a driver area and a second surface facing a passenger area with said first surface supporting said semitransparent screen.

24. The instrument display panel as recited in claim 23 wherein said first and second surfaces have a generally identical appearance when a vehicle ignition is deactivated, and wherein said first surface has a different appearance from said second surface when vehicle ignition is activated.

25. A method of displaying a vehicle instrument panel comprising the steps of:
(a) projecting a light from a primary light system;
(b) directing the light toward a vehicle dash using a primary optical system; and
(c) displaying a primary image on a semitransparent screen supported by the dash.

26. The method as recited in claim 25 wherein said step (c) further includes displaying at least one variable vehicle condition.

27. The method as recited in claim 25 wherein step (b) further includes directing the light toward the semitransparent screen using a reflector.

28. The method as recited in claim 27 wherein said step (b) further includes adjusting the reflector position relative to the primary light system.

29. The method as recited in claim 25 wherein said step (a) further includes activating a vehicle ignition to supply power to the primary light system and the primary optical system.

30. The method as recited in claim 25 wherein said step (a) further includes producing a first light at first wavelength and producing a second light at a second wavelength.

31. The method as recited in claim 25 further including:
(d) projecting a second light from a second light source;
(e) directing the second light toward the dash using a second optical system; and
(f) simultaneously displaying the first image and a second image on the semitransparent screen.

32. The method as recited in claim 31 where said step (d) further includes projecting light from the second light source through a scale to produce an image of a scale with the primary optical system and primary light source producing an image of a pointer.

33. The method as recited in claim 31 wherein said step (d) further includes activating a vehicle ignition to supply power to the second light source and the second optical system.

34. The method as recited in claim 31 wherein said step (e) further includes directing the second light through a lens as it passes through the second optical system.

35. The method as recited in claim 31 wherein the second light source is a guide light source and the second optical system is a light guide, further including:
(g) projecting light from a guide light source;
(h) directing the light toward the semitransparent screen using a light guide;
(i) producing an image by directing the light through graphics printed on the light guide;
(j) displaying the second image on the semitransparent screen.

36. The method as recited in claim 35 wherein said step (a) further includes projecting light from the primary light system through a pointer to produce the primary image.

37. The method as recited in claim 37 wherein said step (a) further includes moving the pointer with an electric motor to reflect changes in a vehicle condition.

38. The method as recited in claim 35 wherein said step (g) further includes activating a vehicle ignition to supply power to the primary light system and the primary optical system.
